(19) United States
(12) Patent Application Publication
(10) Pub. No.: US 2009/0153902 A1
(43) Pub. Date: Jun. 18, 2009

(54) INFORMATION PROCESSING APPARATUS, JOB EXECUTION INSTRUCTING METHOD, AND RECORDING MEDIUM STORING JOB EXECUTION INSTRUCTING PROGRAM

(75) Inventor: Taro YAMAMOTO, Amagasaki-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/336,142

(22) Filed: Dec. 16, 2008

(30) Foreign Application Priority Data
Dec. 17, 2007 (JP) 2007-325320

(51) Int. Cl. G06F 15/00

(52) U.S. Cl. 358/1.15

(57) ABSTRACT

In an information processing apparatus, if a target file to be used for job execution, which is stored in a directory, is detected as being dragged and dropped into an icon instructing to execute a job, the directory storing the target file is detected from the target file itself. And a job execution condition applied to the detected directory, which is stored in an execution condition storage, is given to the target file. And then, a controller outputs a job execution instruction to a job execution apparatus, in order to execute a job about the target file under the job execution condition given thereto.

This application claims priority under 35 U.S.C. §119 to Japanese Patent Application No. 2007-325320 filed on Dec. 17, 2007, the entire disclosure of which is incorporated herein by reference in its entirety.

### BACKGROUND OF THE INVENTION

1. Field of the Invention

The present invention relates to an information processing apparatus such as a personal computer (hereinafter to be referred to as “PC”) that outputs a job execution instruction to a job execution apparatus such as an image forming apparatus, a job execution instructing method, and a computer readable recording medium storing in itself a job execution instructing program to make a computer execute processing.

2. Description of the Related Art

The following description sets forth the inventor's knowledge of related art and problems therein and should not be construed as an admission of knowledge in the prior art.

It is heretofore known that a print icon instructing a printing apparatus to execute a print job under a specified condition is displayed on a screen of a display, and if a user drags and drops a print target file into the print icon displayed thereon, then a print instruction to print the file is outputted to the printing apparatus, and then the printing apparatus executes a print job accordingly (for example as referred to Japanese Unexamined Laid-open Patent Publications No. 2004-110741, No. 2006-120041 and No. 2006-195562).

Specifically as disclosed in Japanese Unexamined Laid-open Patent Publication No. 2006-195562, a plurality of icons each representing a print folder are created as sub folders hierarchically in the lower tier of another icon representing a print folder, and these icons are displayed in a tree structure.

However, there exist some inconveniences with these conventional arts in which a print job is executed if a print target file is dragged and dropped into a print icon instructing to execute a print job. That is, in order to print a print target file under different print conditions, a plurality of print icons each having a different print condition should be created and displayed. Furthermore, more print conditions may cause more troubles in creating print icons, meanwhile more print icons displayed on a screen may cause more troubles in selecting a preferable print icon among those displayed.

Such inconveniences occur not only when a print job is executed, but also when other jobs are executed, for example when a job to transmit image data to an external device is executed.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The Preferred embodiments of the present invention can significantly improve upon existing methods and/or apparatuses.

It is an objective of the present invention to provide an information processing apparatus that allows users to drag and drop a print target file into an icon instructing job execution, and is capable of executing a job under a plurality of conditions and skipping the operations of creating or displaying a plurality of icons instructing job execution.

It is another objective of the present invention to provide a job execution instructing method that allows users to drag and drop a print target file into an icon instructing job execution, and is capable of executing a job under a plurality of conditions and skipping the operations of creating or displaying a plurality of icons instructing job execution.

It is yet another objective of the present invention to provide a computer readable recording medium storing in itself a job execution instructing program to make a computer execute processing by the job execution instructing method.

According to a first aspect of the present invention, an information processing apparatus includes:
a file storage that is capable of having one or more than one directory storing a target file to be used for job execution;
an execution condition storage that is capable of storing a job execution condition applied to the directory, which is set in advance;
a display that is capable of displaying on itself an icon instructing a job execution apparatus to execute a job;
a drag and drop detector that detects the target file as being dragged and dropped into the icon;
a directory detector that detects the directory storing the target file, from the target file itself, if the target file is detected as being dragged and dropped into the icon;
a setting portion that gives to the target file, a job execution condition applied to the directory detected by the directory detector, which is preliminarily stored in the execution condition storage; and
a controller that outputs a job execution instruction to the job execution apparatus, in order to execute a job about the target file under the job execution condition given thereto.

According to a second aspect of the present invention, a job execution instructing method includes:
detecting a target file to be used for job execution, which is stored in one or more than one directory created in a file storage, as being dragged and dropped into an icon instructing a job execution apparatus to execute a job, displayed on a display;
detecting a directory storing the target file, from the target file itself, if the target file is detected as being dragged and dropped into the icon;
giving to the target file, a job execution condition applied to the detected directory, which is preliminarily stored in an execution condition storage; and
outputting a job execution instruction to the job execution apparatus, in order to execute a job about the target file under the job execution condition given thereto.

According to a third aspect of the present invention, a computer readable recording medium stores a job execution instructing program in itself to make a computer execute:
detecting a target file to be used for job execution, which is stored in one or more than one directory created in a file storage, as being dragged and dropped into an icon instructing a job execution apparatus to execute a job, displayed on a display;
detecting a directory storing the target file, from the target file itself, if the target file is detected as being dragged and dropped into the icon;
giving to the target file, a job execution condition applied to the detected directory, which is preliminarily stored in a job execution condition storage; and
outputting a job execution instruction to the job execution apparatus, in order to execute a job about the target file under the job execution condition given thereto.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a block diagram showing a configuration of a printing system in which an information processing apparatus according to one embodiment of the present invention is employed;

FIG. 2 is a block diagram showing a configuration of the information processing apparatus;

FIG. 3 is a view to explain a method for a user using the information processing apparatus shown in FIG. 2 to print a target file, and an operation performed in the information processing apparatus for the meanwhile;

FIG. 4 is a view to explain how to create in the lower tier of a setting change folder, another setting change folder;

FIG. 5 is a flowchart showing a procedure executed in the information processing apparatus when a user hopes to print a target file by the method explained with FIG. 3;

FIG. 6 is a view to explain another method for a user using the information processing apparatus shown in FIG. 2 to print a target file, and an operation performed in the information processing apparatus for the meanwhile;

FIG. 7 is a view showing an example described in a sub setting file;

FIG. 8 is a view showing another example described in a sub setting file; and

FIG. 9 is a flowchart showing a procedure executed in the information processing apparatus when a user hopes to print a target file by the method explained with FIG. 6.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

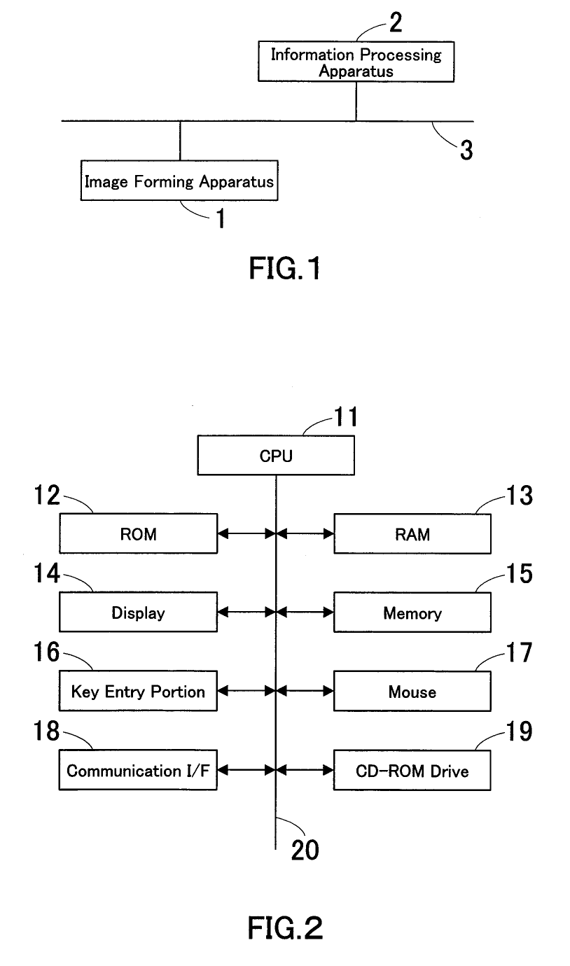

As shown in FIG. 1, a job execution system includes an information processing apparatus 1 and an image forming apparatus 2 that is a job execution apparatus such as a MFP (Multi Function Peripheral) i.e. a multifunctional digital machine, and these apparatuses are connected to each other via a network 3.

This embodiment will be explained under the assumption that the information processing apparatus 1 is a personal computer and a job executed according to an instruction transmitted from the information processing apparatus 1, is a print job.

In the block diagram shown in FIG. 2, the information processing apparatus 1 includes a CPU 11, a ROM 12, a RAM 13, a display 14, a memory 15, a key entry portion 16, a mouse 17, a communication interface (communication I/F) 18, a CD-ROM drive 19 and etc., and these portions are connected to each other via a system bus 20.

The CPU 11 centrally controls the entire information processing apparatus 1 by executing a program stored in the ROM 12. In this embodiment, the CPU 11 detects whether or not a target file stored in one or more than one directory existing in the memory 15 is dragged and dropped into an icon instructing to execute a print job (hereinafter also to be referred to as “print application icon”) displayed on the display 14. And if detects that such a target file is dragged and dropped, the CPU 11 further detects a directory storing the target file, then gives to the target file a print execution condition applied to the detected directory. Meanwhile, the CPU 11 changes the print execution condition given thereto. And the CPU 11 outputs a print execution instruction to the image forming apparatus 2 in order to execute a print job about the target file under the given or changed print execution condition. Detailed explanation will be provided later.

The ROM 12 is a recording medium that stores in itself an operation program executed by the CPU 11 and other data.

The RAM 13 is a recording medium that provides a work area in which the CPU 11 works according to an operation program.

The display 14 is a CRT display, a liquid crystal display or etc., and displays on itself various messages for users, screens such as an entry screen and a selection screen for users, documents created by users, and etc. In this embodiment, the display 14 also displays a print application icon instructing to execute a print job as described above, and others.

The memory 15 is a recording medium such as a hard disk drive, and stores in itself various application programs, data and etc.

The key entry portion 16 and the mouse 17 are used by uses to perform entry operations.

The communication interface (communication I/F) 18 functions as a communicator that exchanges data with the image forming apparatus 2 and other external devices via the network 3. In this embodiment, the communication I/F 18 transmits to the image forming apparatus 2, a target file together with a print command and a print execution condition given to the target file, so that the image forming apparatus 2 could print the target file.

The CD-ROM drive 19 drives a CD-ROM.

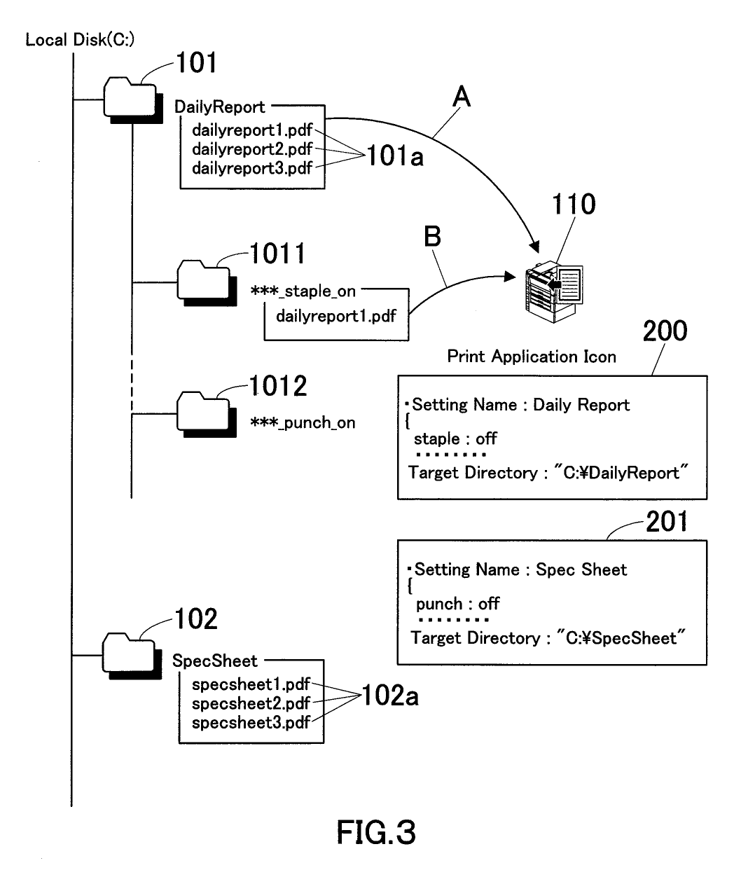

As shown in FIG. 3, there exist in a data storage area (this corresponds to “Local Disk (C:)” in FIG. 3) of the memory 15, one or more than one directory storing target files. For example, there exist a directory 101 referred to by the directory information “C: [symbol] DailyReport” and a directory 102 referred to by the directory information “C: [symbol] SpecSheet”. And the directory 101 stores target files 101a that are “dailyreport1.pdf”, “dailyreport2.pdf” and “dailyreport3.pdf” and the directory 102 stores target files 102a that are “specsheet1.pdf”, “specsheet2.pdf” and “specsheet3.pdf”, respectively.

Furthermore, the directory 101 stores as lower-tier folders, setting change folders 1011 and 1012 to change a print execution condition given to a target file. And the setting change folders 1011 and 1012 have folder names including change information to change the print execution condition. For example in FIG. 3, the setting change folder 1011 is named as “***_staple_on”, indicating that the print execution condition should be changed in order to perform a stapling operation, and the setting change folder 1012 is named as “***_punch_on”, indicating that the print execution condition should be changed in order to perform a punching operation.

The string “***” is given at the top of the folder names of the lower-tier folders 1011 and 1012, so that these folders could be recognized as setting change folders, and also so that the string (for example, “_staple_on” and etc. in FIG. 3) following “***” could be used as a directory name.

Furthermore, there stored in the memory 15, print execution conditions applied to the directories 101 and 102, which are preliminarily described in setting information. For example in FIG. 3, according to setting information 200 with the setting name “Daily Report”, “staple: off” is described as a print execution condition and the condition is set for the directory 101. And according to setting information 201 with the setting name “Spec Sheet”, “punch: off” is described as a print execution condition and the condition is set for the directory 102.

In order to print a preferable file, a user selects an icon representing a target file to be printed (instead of such an icon, a string indicating a file name may be displayed on the display 14 depending on its displaying style. Such those that may be displayed will be collectively referred to as “icons” here in this embodiment), which is stored in a directory, then drags and drops the target file into a print application icon 110. And under the control of the CPU 11, if the target file is detected as being dragged and dropped into the print application icon 110, then a directory storing the dragged and dropped file is detected.

For example as indicated by Arrow A in FIG. 3, if the target file 101a “dailyreport1.pdf” stored in the directory 101 referred to by “C: [symbol] DailyReport”, is dragged and dropped, the directory 101 is detected according to the directory information “C: [symbol] DailyReport” indicating the storage location of the target file 101a.

After detecting the directory 101, under the control of the CPU 11, directories described in the setting information 200 and 201 and the detected directory 101 referred to by “C: [symbol] DailyReport” are compared, and thereby a matched directory is detected. And then, a print execution condition described together with the matched directory in any of the setting information is given to the target file 101a. “dailyreport1.pdf” that is dragged and dropped. If no matched directory is detected, a default print execution condition is given to the target file 101a, or a user is allowed to give a preferable condition via a dialog coming up on a screen.

Subsequently, under the control of the CPU 11, a print execution instruction is outputted to the image forming apparatus 2 in order to execute a print job about the target file 101a under the print execution condition given thereto.

Meanwhile, a user can have the target file 101a printed under a different print execution condition. For example, in order to change the condition “staple: off” described for the target file 101a “dailyreport1.pdf” in the setting information 200, to “staple: on”, a user initially copies the target file 101a “dailyreport1.pdf” into the lower-tier folder 1011 “***_staple_on”, as shown in FIG. 3.

Subsequently, as indicated by Arrow B in FIG. 3, the user drags and drops the target file 101a copied into the lower-tier folder 1011, into the print application icon 110.

And under the control of the CPU 11, if the target file 101a is detected as being dragged and dropped, then the directory 101 storing the dragged and dropped file 101a is detected. For example, the directory 101 referred to by “C: [symbol] DailyReport”, is detected according to the directory information “C: [symbol] DailyReport [symbol] ***_staple_on” indicating the storage location of the target file 101a.

After detecting the directory 101, under the control of the CPU 11, directories described in the setting information 200 and 201 and the detected directory 101 referred to by “C: [symbol] DailyReport” are compared, and thereby a matched directory is detected. And then, a print execution condition described together with the matched directory in any of the setting information is given to the target file 101a that is dragged and dropped.

Subsequently, according to the folder name “***_staple_on” included in the directory information, a staple part of the print execution condition given to the target file 101a, is changed to “staple: on”. And then a print execution instruction is outputted to the image forming apparatus 2.

After outputting a print execution instruction, under the control of the CPU 11, the target file 101a copied into the setting change folder 1011 is automatically deleted, and thereby the setting change folder 1011 recovers the initial condition as it was before copying the file.

Meanwhile, if a setting error (prohibition) happens to occur during changing the print execution condition, a user is requested to select via a dialog displayed on a screen of the display 14, whether to cancel the condition setting operation or to cancel the print job.

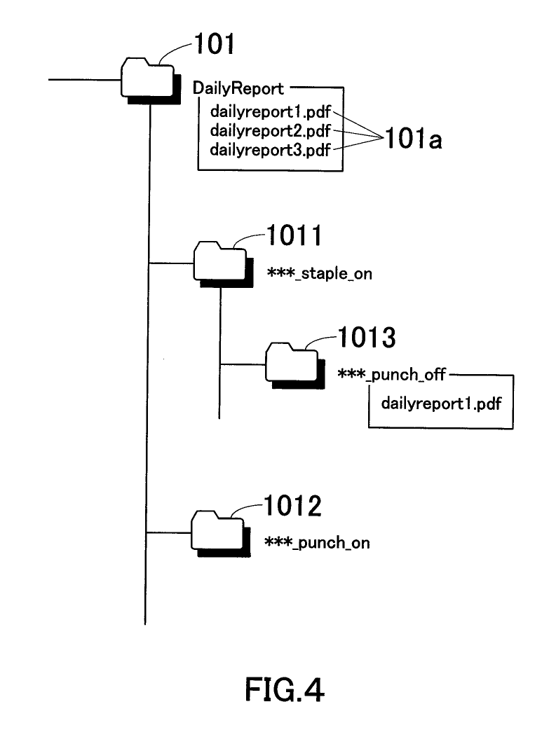

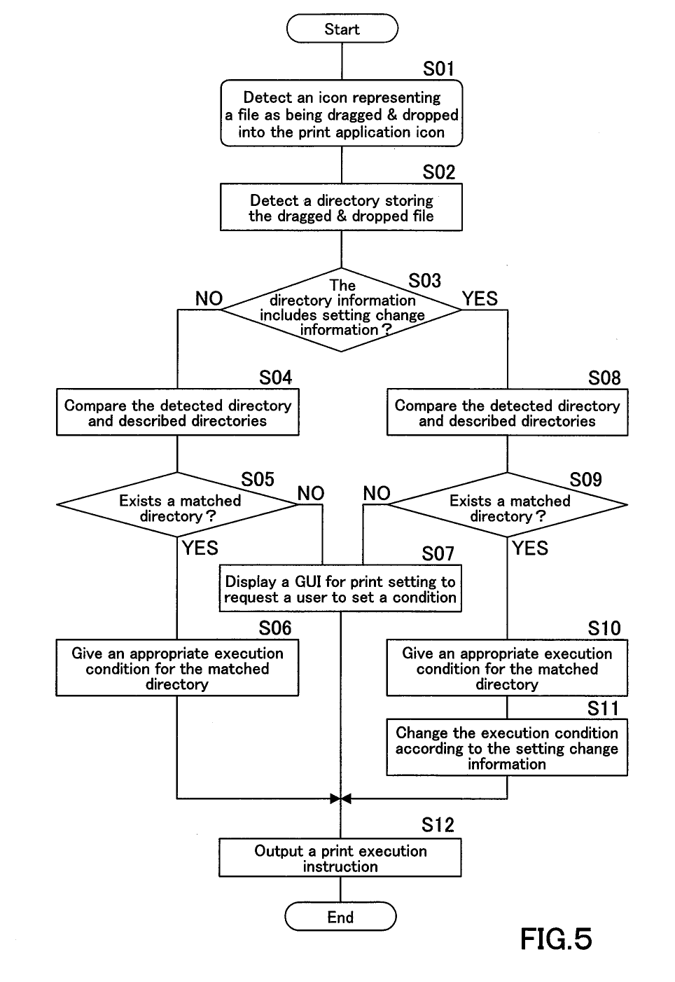

Furthermore, another setting change folder may be created in the lower tier of the setting change folders 1011 and 1012. For example, as shown in FIG. 4, a setting change folder 1013 with the name “***_punch_off” is created as a lower-tier folder of the setting change folder 1101. The name “***_punch_off” indicates that the print execution condition should be changed in order not to perform a punching operation.

The usage of the setting change folder 1013 is as following. For example, if a print execution condition given to the target file 101a stored in the directory 101 is “staple: off” and “punch: on”, in order to change the print execution condition to “staple: on” and “punch: off” and print the target file 101a under the changed condition, a user initially copies the target file 101a stored in the directory 101, into the lower-tier folder 1013 “***_punch_off”, as shown in FIG. 4.

Subsequently, the user drags and drops the target file 101a copied into the lower-tier folder 1013, into the print application icon 110.

And under the control of the CPU 11, if the target file 101a is detected as being dragged and dropped, then the directory storing the dragged and dropped file is detected. For example, the directory 101 referred to by “C: [symbol] DailyReport”, is detected according to the directory information “C: [symbol] DailyReport [symbol] ***_staple_on [symbol] ***_punch_off”.

After detecting the directory 101, under the control of the CPU 11, directories described in the setting information 200 and 201 and the detected directory 101 referred to by “C: [symbol] DailyReport” are compared, and thereby a matched directory is detected. And then, a print execution condition described together with the matched directory in any of the setting information is given to the target file 101a that is dragged and dropped.

Subsequently, according to the folder names “***_staple_on” and “***_punch_off” included in the directory information of the target file 101a, a staple part and a punch part of the print execution condition given to the target file 101a, are changed to “staple: on” and “punch: off”, respectively. And then a print execution instruction is outputted to the image forming apparatus 2.

Furthermore, other setting change folders may be created as lower-tier folders of the setting change folder 1013. In this way, three or more than three setting change instructions may be given at the same time.

Hereinafter, a procedure executed in the information processing apparatus 1 when a user hopes to print a target file by the method explained with FIG. 3, will be explained with reference to a flowchart shown in FIG. 5. This procedure is executed by the CPU 11 according to a print application program stored in the memory 15 or the ROM 12.

In Step S01, an icon representing the target file 101a is detected as being dragged and dropped into the print application icon 110. Then the directory 101 storing the dragged and dropped file 101a is detected in Step S02.

Subsequently, it is judged in Step S03 whether or not the directory information includes setting change information (folder name of a setting change folder). And if the directory information does not include any setting change information (NO in Step S03), the detected directory and directories described in the setting information 200 and 201 are compared in Step S04, and it is judged in Step S05 whether or not there exists a matched directory. If there exists a matched directory (YES in Step S05), an execution condition described together with the matched directory in any of the setting information is given to the target file 101a, in Step S06. And then, a print execution instruction is outputted to the image forming apparatus 2, with the execution condition given thereto.

If there does not exist any matched directory in Step S05 (NO in Step S05), a GUI (Graphical User Interface) for print setting is displayed and a user is requested to set a preferable condition via the GUI, in Step S07. And then in Step S12, a print execution instruction is outputted to the image forming apparatus 2, with the execution condition given thereto.

On the other hand, if the directory information includes setting change information (YES in Step S03), the detected directory and directories described in the setting information 200 and 201 are compared in Step S05, and it is judged in Step S09 whether or not there exists a matched directory. If there exists a matched directory (YES in Step S09), a print execution condition described together with the matched directory in the setting information is given to the target file 101a, in Step S10. And the execution condition given thereto is changed according to the setting change information, in Step S11. And then in Step S12, a print execution instruction is outputted to the image forming apparatus 2, with the changed execution condition.

If there does not exist any matched directory in Step S09 (NO in Step S09), the routine proceeds to Step S07, in which a GUI for print setting is displayed on the display and a user is requested to set a preferable condition via the GUI. And then in Step S12, a print execution instruction is outputted to the image forming apparatus 2, with the execution condition given thereto.

As described above in this embodiment, there stored in the memory 15, the setting information 200 and 201 in which a print execution condition applied to a directory is preliminarily described, and an execution condition applied to a directory storing a target file is identified according to the setting information and is given to the target file. That is, in order to print a target file under a plurality of different print execution conditions, the target file should be stored in each plurality of directories and an appropriate print execution condition for each of the directories should be preliminarily described in the setting information stored in the memory 15. With such a configuration above, a directory storing a target file that is dragged and dropped into a print application icon, is detected from the target file, and an execution condition applied to the directory is automatically given to the target file, then the target file is printed accordingly. Therefore, only one print application icon is enough and a plurality of print application icons each instructing to execute a print job under a different execution condition do not have to be created or displayed any more. Furthermore, mis-selection could not occur any more because users do not have to select a preferable one among a plurality of print application icons.

Furthermore, the print execution condition given to the target file can be changed without difficulty, by using a setting change folder.

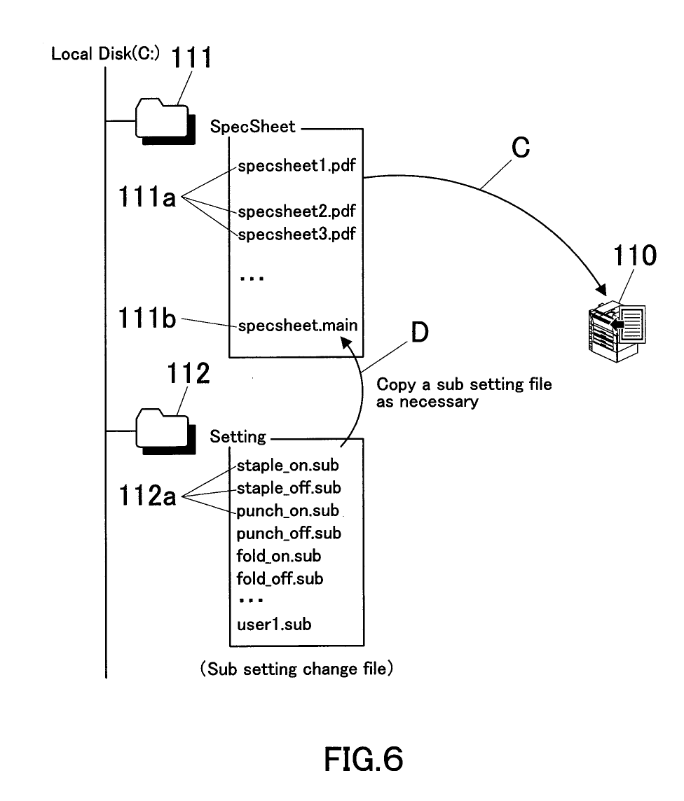

Hereinafter, another method for a user using the information processing apparatus 1 shown in FIG. 2 to print a target file, and an operation performed in the information processing apparatus 1 for the meanwhile, will be explained with reference to FIG. 6.

As shown in FIG. 6, there exist in the data storage area (“Local Disk (C:)”) of the memory 15, one or more than one directory 111 storing target files, and one or more than one directory 112 storing sub setting files for execution condition change.

For example, the directory 111 named as “spec sheet”, stores the target files 111a such as “specsheet1.pdf”, “specsheet2.pdf” and “specsheet3.pdf”, as well as a main setting file 111b. The main setting file 111b is used to change a default print execution condition, and the main setting file 111b has a print execution condition described by a user. Since the directory 111 stores the main setting file 111b, a print execution instruction to print the target files 111a also stored in the directory 111, is outputted with the execution condition described in the main setting file 111b.

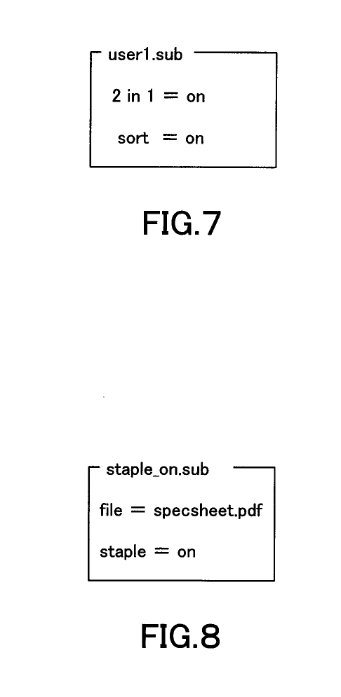

On the other hand, for example, the directory 112 (named as “Setting” in FIG. 6) stores sub setting files for execution condition change 112a with the names such as “staple_on.sub”, “staple_off.sub”, “punch_on.sub”, “punch_off.sub”, “fold_on.sub”, “fold_off.sub” and “user1.sub”. “Staple_on” and “staple_off” indicate that a stapling operation should be on and off as previously described, and according to the description in those files, a target file should be stapled or not stapled. In the same way, “punch_on” and “punch_off” indicate that a punching operation should be on and off, and “fold_on” and “fold_off” indicate that a folding operation such as Z-folding should be on and off, and according to the description in those files, a target file should be punched or not punched and should be folded or not folded, respectively. Meanwhile, the sub setting file 112a “user1.sub” has an original execution condition described by a user, indicating that a 2-in-1 operation to print two sheets of data on one sheet should be on, and also a sorting operation should be performed, for example as shown in FIG. 7.

Detailed operations will be provided as following. As indicated by Arrow C in FIG. 6, a user drags and drops the target file 111a stored in the directory 111, into the print application icon 110. Under the control of the CPU 11, if the target file 111a is detected as being dragged and dropped, then the directory 111 storing the dragged and dropped file 111a is detected according to the directory information “C: [symbol] SpecSheet”.

Usually, a default print execution condition is outputted to the image forming apparatus 2 by the print application icon 110.

After detecting the directory 111, under the control of the CPU 11, the main setting file 111b stored in the detected directory 111 is scanned. Then, instead of the default print execution condition, a print execution condition described in the main setting file 111b is given to the target file 111a.

Subsequently, under the control of the CPU 11, a print execution instruction is outputted to the image forming apparatus 2 in order to execute a print job about the target file 111a under the print execution condition given thereto.

Meanwhile, if there does not exist any main setting file 111b in the detected directory 111, the default print execution condition is employed.

In order to change the print execution condition described in the main setting file 111b, a user should perform the following operation. That is, as indicated by Arrow D in FIG. 6, the user copies into the directory 111 storing the target file 111a, the sub setting file 112a that is stored in the directory 112 and has a preferable condition described therein. For example, if he/she hopes to change “staple: off” to “staple: on”, he/she copies the sub setting file 112a “staple_on.sub” into the directory 111. As a matter of course, he/she may copy a plurality of the sub setting files 112a into the directory 111 as necessary.

If a user copies the sub setting file 112a then drags and drops the target file 111a, the main setting file 111b and the sub setting file 112a stored in the detected directory 111, are scanned. Then, an execution condition described in the main setting file 111b and given to the target file 111a, is changed according to a description in the sub setting file 112a.

After outputting a print execution instruction, the sub setting file 112a copied into the directory 111 is automatically deleted, and thereby the directory 111 recovers the initial condition as it was before copying the sub setting file 112a.

Meanwhile, if a setting error (prohibition) happens to occur during giving the execution condition by using the main setting file 111b or during changing the execution condition by using the sub setting file 112a, a user is requested to select via a dialog displayed on a screen of the display 14, whether to cancel the condition setting operation or to cancel the print job.

Furthermore, in this embodiment, in order to print the target file 111a stored in the directory 111, under an execution condition other than that described in the main setting file 111b, the sub setting file 112a may be directly related to the target file 111a, by describing the target file 111a (for example “specsheet.pdf” in FIG. 8) in the sub setting file 112a as shown in FIG. 8. In this case, if a user copies into the directory 111, the sub setting file 112a directly related to the target file 111a then drags and drops a target file other than the target file 111a, the description read out from the sub setting file 112a is ignored and the print execution condition is never changed. Furthermore, the sub setting file 112a that is copied into the directory 111 and directly related to the target file 111a, is never deleted automatically after executing the print job.

Meanwhile, the sub setting file 112a may be directly related to the target file 111a by a print application program, not by describing the target file 111a in the sub setting file 112a. For example, a print application program specifies the sub setting file 112a “staple_on.sub” to be effective only for the target file 111a.

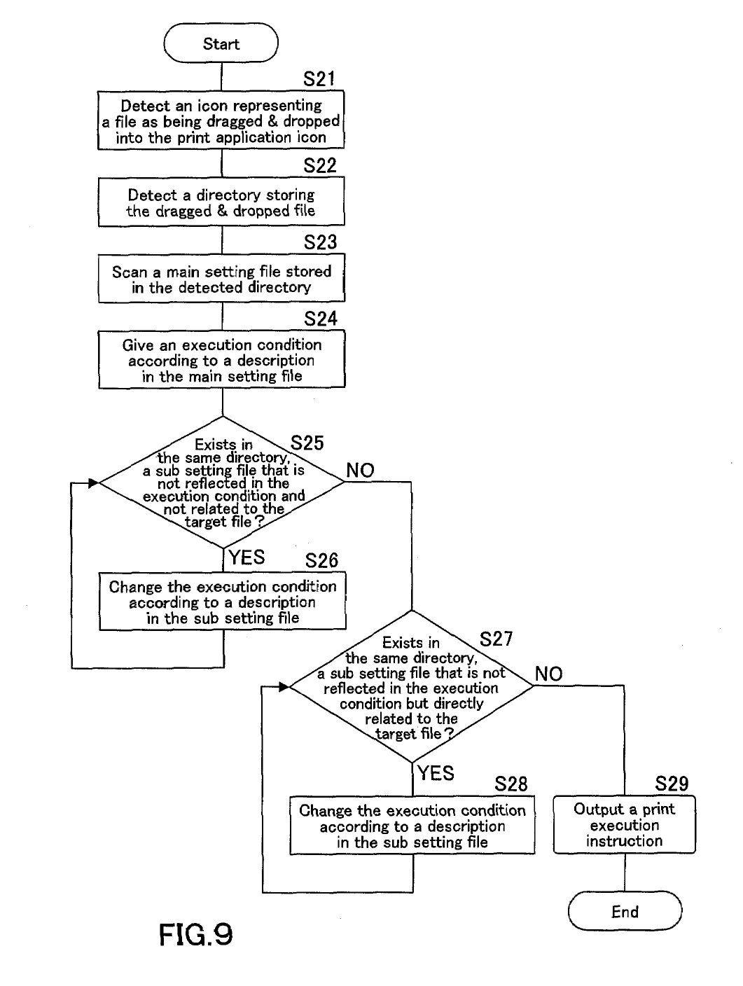

A procedure executed in the information processing apparatus 1 when a user hopes to print the target file 111a by the method explained in FIG. 6, will be explained with reference to a flowchart shown in FIG. 9. This procedure is executed by the CPU 11 according to a print application program stored in the memory 15 or the ROM 12.

In Step S21, an icon representing the target file 111a is detected as being dragged and dropped into the print application icon 110. Then the directory 111 storing the dragged and dropped file 111a is detected in Step S22.

Subsequently, the main setting file 111b stored in the detected directory 111 is scanned in Step S23. And a print execution condition is given to the target file 111a according to a description in the main setting file 111b, in Step S24

Then it is judged in Step S25, whether or not there exists in the same directory 111, a sub setting file 112a that is not reflected in the print execution condition and not directly related to the target file 111a. If there exists such a sub setting file 112a (YES in Step S25), the print execution condition given thereto is changed according to a description in the sub setting file 112a, in Step S26. If there exist a plurality of sub setting files 112a that are not reflected in the print execution condition and not related to the target file 111a directly, the routine repeats Steps S25 and S26.

If there does not exist any sub setting file 112a that is not reflected in the print execution condition and not directly related to the target file 111a (NO in Step S25), then it is judged in Step S27 whether or not there exists a sub setting file 112a that is not reflected in the print execution condition but directly related to the target file 111a. If there exists such a sub setting file 112a (YES in Step S27), the execution condition is changed according to a description in the sub setting file 112a, in Step S28. If there exist a plurality of sub setting files 112a that are not reflected in the print execution condition but directly related to the target file 111a (NO Step S27), the routine repeats Steps S27 and S28.

If there does not exist any sub setting file 112a that is not reflected in the print execution condition but directly related to the target file 111a (NO in Step S27), a print execution instruction is outputted to the image forming apparatus 2, with the given or changed print execution condition, in Step S29.

As described above in this embodiment, a directory stores a main setting file in which a print execution condition applied to the directory is preliminarily described. The main setting file is scanned, and thereby the print execution condition described therein is detected and given to a target file that is stored in the same directory. That is, in order to print a target file under a plurality of different print execution conditions, the target file and a main setting file should be stored in each plurality of directories. With such a configuration above, a directory storing a target file that is dragged and dropped into a print application icon is detected; a main setting file stored in the directory is scanned; an execution condition is automatically given to the target file; and the target file is printed accordingly. Therefore, only one print application icon is enough and a plurality of print application icons each instructing to execute a print job under a different execution condition do not have to be created or displayed any more. Furthermore, mis-selection could not occur any more because users do not have to select a preferable one among a plurality of print application icons.

Furthermore, the print execution condition given to the target file can be changed without difficulty, by using a sub setting file.

Described above relates to one embodiment of the present invention. However, the present invention is not limited to this embodiment. A target job executed in this embodiment is a print job for example and not necessarily limited to a print job. Alternatively, it may be another job such as a transmission job to transmit image data to an external device.

### Summary of The Embodiment

In the embodiment explained above, the following information processing apparatus, job execution instructing method and computer readable recording medium storing in itself a job execution instructing program to make a computer execute processing, are employed.

[1] An information processing apparatus including: a file storage that is capable of having one or more than one directory storing a target file to be used for job execution; an execution condition storage that is capable of storing a job execution condition applied to the directory, which is set in advance; a display that is capable of displaying on itself an icon instructing a job execution apparatus to execute a job; a drag and drop detector that detects the target file as being dragged and dropped into the icon; a directory detector that detects the directory storing the target file, from the target file itself, if the target file is detected as being dragged and dropped into the icon; a setting portion that gives to the target file, a job execution condition applied to the directory detected by the directory detector, which is preliminarily stored in the execution condition storage; and a controller that outputs a job execution instruction to the job execution apparatus, in order to execute a job about the target file under the job execution condition given thereto.

With this information processing apparatus, if a target file that a job is to be executed about and is stored in a directory, is detected as being dragged and dropped into an icon instructing to execute a job, the directory storing the target file is detected. And a job execution condition applied to the detected directory, which is stored in an execution condition storage, is given to the target file. Then a job execution instruction is outputted to a job execution apparatus in order to execute a job about the target file under the job execution condition given thereto. That is, in order to execute a job under a plurality of different job execution conditions, a target file that a job to be executed about, should be stored in each plurality of directories and a job execution condition applied to each of the directories should be preliminarily stored in the execution condition storage. With such a configuration above, a directory storing a target file that is dragged and dropped into an icon is detected, and an execution condition applied to the directory is automatically given to the target file, then a job is executed accordingly. Therefore, only one icon instructing job execution is enough and a plurality of icons each instructing to execute a job under a different execution condition do not have to be created or displayed any more. Furthermore, mis-selection could not occur any more because users do not have to select a preferable one among a plurality of print application icons.

[2] The information processing apparatus described above, further including: a setting change information storage that is capable of storing setting change information to change a job execution condition applied to the directory detected by the directory detector; and a changer that changes the job execution condition given to the target file, according to the setting change information stored in the setting change information storage, and wherein the controller outputs a job execution instruction to the job execution apparatus, in order to execute a job about the target file under the job execution condition changed by the changer.

With this information processing apparatus, the job execution condition given thereto can be changed according to setting change information.

[3] The information processing apparatus described above, wherein the directory storing the target file also stores a setting change folder with a folder name including the setting change information, and further comprising a copier that copies the target file into the setting change folder according to a user instruction, and wherein the changer changes the job execution condition given to the target file, according to the setting change information extracted from the folder name, if the target file copied into the setting change folder is dragged and dropped into the icon.

With this information processing apparatus, the job execution condition given thereto is changed according to the setting change information extracted from a folder name of a setting change folder, if the target file copied into the setting change folder is dragged and dropped into the icon.

[4] The information processing apparatus described above in [3], further including a deletion portion that deletes the target file copied into the setting change folder, after the controller outputs a job execution instruction.

With this information processing apparatus, the target file copied into the setting change folder is deleted after a job execution instruction is outputted, and thereby the setting change folder recovers the initial condition as it was before copying the target file.

[5] The information processing apparatus described above in [1], wherein: the job execution condition is described in a setting change file stored in the same directory as the target file; and the setting portion gives to the target file, a job execution condition extracted from the setting change file that is stored in the directory detected by the directory detector.

With this information processing apparatus, a job is executed under a job execution condition described in a setting change file that is stored together with the target file in the directory detected by the directory detector.

[6] The information processing apparatus described in [5], further including: a setting change information storage that is capable of storing setting change information to change a job execution condition applied to the directory; a copier that copies the stored setting change information into the directory, according to a user instruction; and a changer that changes the job execution condition given by the setting portion to the target file, according to the setting change information extracted from the directory detected by the directory detector, if the target file stored in the directory having the setting change information copied therein, is detected as being dragged and dropped into the icon, and wherein the controller outputs a job execution instruction in order to execute a job under the job execution condition changed by the changer.

With this information processing apparatus, the job execution condition given thereto is properly changed according to the setting change information copied into the directory detected by the directory detector.

[7] The information processing apparatus described in [6], further including a deletion portion that deletes the setting change information copied into the directory, after the controller outputs a job execution instruction.

With this information processing apparatus, the setting change information copied into the directory is deleted after a job execution instruction is outputted, and thereby the directory recovers the initial condition as it was before copying the setting change information.

[8] The information processing apparatus described in any of [1] through [7], wherein the job corresponds to a print job. With this information processing apparatus, in order to execute a print job under a plurality of print conditions, the target file stored in each of the different directories should be simply dragged and dropped into an icon instructing to execute a print job, and no matter the icon is only one.

[9] A job execution instructing method including: detecting a target file to be used for job execution, which is stored in one or more than one directory created in a file storage, as being dragged and dropped into an icon instructing a job execution apparatus to execute a job, displayed on a display; detecting a directory storing the target file, from the target file itself, if the target file is detected as being dragged and dropped into the icon; giving to the target file, a job execution condition applied to the detected directory, which is preliminarily stored in an execution condition storage; and outputting a job execution instruction to the job execution apparatus, in order to execute a job about the target file under the job execution condition given thereto.

With this job execution instructing method, in order to execute a job under different job execution conditions, a target file that a job to be executed about and is stored in each different directory, should be simply dragged and dropped into one icon instructing job execution. Therefore, a plurality of icons each instructing to execute a job under a different execution condition do not have to be created or displayed any more.

[10] A computer readable recording medium stores in itself a job execution instructing program to make a computer execute: detecting a target file to be used for job execution, which is stored in one or more than one directory created in a file storage, as being dragged and dropped into an icon instructing a job execution apparatus to execute a job, displayed on a display; detecting a directory storing the target file, from the target file itself, if the target file is detected as being dragged and dropped into the icon; giving to the target file, a job execution condition applied to the detected directory, which is preliminarily stored in a job execution condition storage; and outputting a job execution instruction to the job execution apparatus, in order to execute a job about the target file under the job execution condition given thereto.

With this recording medium, in order to output different job execution conditions to the job execution apparatus, a target file that a job is to be executed about and is stored in each different directory, should be simply dragged and dropped into one icon instructing job execution.

[11] The computer readable recording medium described in [10], wherein a setting change information storage that is capable of storing setting change information to change a job execution condition applied to the directory detected in the detecting step, also stores the job execution instructing program, further making the computer execute changing the job execution condition given to the target file, according to the stored setting change information, and wherein a job execution instruction is outputted in the outputting step, in order to execute a job under the job execution condition changed in the changing step.

With this recording medium, the job execution condition given thereto is changed according to setting change information.

[12] The computer readable recording medium described in [11], wherein the directory storing the target file, also stores a setting change folder with a folder name including the setting change information, further making the computer execute copying the target file into the setting change folder according to a user instruction, and wherein the job execution condition given to the target file is changed in the changing step, according to the setting change information extracted from the folder name, if the target file copied into the setting change folder is dragged and dropped into the icon.

With this recording medium, the job execution condition given thereto is changed according to the setting change information extracted from a folder name of a setting change folder, if the target file copied into the setting change folder is dragged and dropped into the icon.

[13] The computer readable recording medium described in [12], further making the computer execute deleting the target file copied into the setting change folder, after a job execution instruction is outputted in the outputting step.

With this recording medium, the target file copied into the setting change folder is deleted after a job execution instruction is outputted, and thereby the setting change folder recovers the initial condition as it was before copying the target file.

[14] The computer readable recording medium described in [10], wherein: the job execution condition is described in a setting change file stored in the same directory as the target file; and a job execution condition extracted from the setting change file stored in the directory detected in the directory detecting step, is given to the target file in the setting step.

With this recording medium, a job is executed under a job execution condition described in a setting change file that is stored together with the target file in the directory detected by the directory detecting step.

[15] The computer readable recording medium described in [10], further making the computer execute: copying into the directory, setting change information stored in a setting change information storage, according to a user instruction; and changing the job execution condition given to the target file in the condition giving step, according to the setting change information extracted from the directory detected in the directory detecting step, if the target file stored in the directory having the setting change information copied therein, is detected as being dragged and dropped into the icon, and wherein a job execution instruction is outputted in the outputting step, in order to execute a job under the job execution condition changed in the changing step.

With this recording medium, the job execution condition given thereto is changed according to the setting change information copied into the directory detected in the directory detecting step.

[16] The computer readable recording medium described in [15], further making the computer execute deleting the setting change information copied into the directory, after a job execution instruction is outputted in the outputting step.

With this recording medium, the setting change information copied into the directory is deleted after a job execution instruction is outputted, and thereby the directory recovers the initial condition as it was before copying the setting change information.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. An information processing apparatus comprising:
a file storage that is capable of having one or more than one directory storing a target file to be used for job execution;
an execution condition storage that is capable of storing a job execution condition applied to the directory, which is set in advance;
a display that is capable of displaying on itself an icon instructing a job execution apparatus to execute a job;
a drag and drop detector that detects the target file as being dragged and dropped into the icon;
a directory detector that detects the directory storing the target file, from the target file itself, if the target file is detected as being dragged and dropped into the icon;
a setting portion that gives to the target file, a job execution condition applied to the directory detected by the directory detector, which is preliminarily stored in the execution condition storage; and
a controller that outputs a job execution instruction to the job execution apparatus, in order to execute a job about the target file under the job execution condition given thereto.

2. The information processing apparatus recited in claim 1, further comprising:
a setting change information storage that is capable of storing setting change information to change a job execution condition applied to the directory detected by the directory detector; and
a changer that changes the job execution condition given to the target file, according to the setting change information stored in the setting change information storage, and
wherein:
the controller outputs a job execution instruction to the job execution apparatus, in order to execute a job about the target file under the job execution condition changed by the changer.

3. The information processing apparatus recited in claim 2, wherein:
the directory storing the target file, also stores a setting change folder with a folder name including the setting change information, and
further comprising:
a copier that copies the target file into the setting change folder according to a user instruction,
and wherein:
the changer changes the job execution condition given to the target file, according to the setting change information extracted from the folder name, if the target file copied into the setting change folder is dragged and dropped into the icon.

4. The information processing apparatus recited in claim 3, further comprising:
a deletion portion that deletes the target file copied into the setting change folder, after the controller outputs a job execution instruction.

5. The information processing apparatus recited in claim 1, wherein:
the job execution condition is described in a setting change file stored in the same directory as the target file; and
the setting portion gives to the target file, a job execution condition extracted from the setting change file that is stored in the directory detected by the directory detector.

6. The information processing apparatus recited in claim 5, further comprising:
a setting change information storage that is capable of storing setting change information to change a job execution condition applied to the directory;
a copier that copies the stored setting change information into the directory, according to a user instruction; and
a changer that changes the job execution condition given by the setting portion to the target file, according to the setting change information extracted from the directory detected by the directory detector, if the target file stored in the directory having the setting change information copied therein, is detected as being dragged and dropped into the icon, and
wherein:
the controller outputs a job execution instruction in order to execute a job under the job execution condition changed by the changer.

7. The information processing apparatus recited in claim 6, further comprising:
a deletion portion that deletes the setting change information copied into the directory, after the controller outputs a job execution instruction.

8. The information processing apparatus recited in claim 1, wherein the job corresponds to a print job.

9. A job execution instructing method comprising:
detecting a target file to be used for job execution, which is stored in one or more than one directory created in a file storage, as being dragged and dropped into an icon instructing a job execution apparatus to execute a job, displayed on a display;
detecting a directory storing the target file, from the target file itself, if the target file is detected as being dragged and dropped into the icon;
giving to the target file, a job execution condition applied to the detected directory, which is preliminarily stored in an execution condition storage; and
outputting a job execution instruction to the job execution apparatus, in order to execute a job about the target file under the job execution condition given thereto.

10. A computer readable recording medium storing in itself a job execution instructing program to make a computer execute:
detecting a target file to be used for job execution, which is stored in one or more than one directory created in a file storage, as being dragged and dropped into an icon instructing a job execution apparatus to execute a job, displayed on a display;
detecting a directory storing the target file, from the target file itself, if the target file is detected as being dragged and dropped into the icon;
giving to the target file, a job execution condition applied to the detected directory, which is preliminarily stored in a job execution condition storage; and
outputting a job execution instruction to the job execution apparatus, in order to execute a job about the target file under the job execution condition given thereto.

11. The computer readable recording medium recited in claim 10, wherein:
a setting change information storage that is capable of storing setting change information to change a job execution condition applied to the directory detected in the detecting step, also stores the job execution instructing program, and
further making the computer execute:
changing the job execution condition given to the target file, according to the stored setting change information, and
wherein:
a job execution instruction is outputted in the outputting step, in order to execute a job under the job execution condition changed in the changing step.

12. The computer readable recording medium executed in claim 11, wherein:
the directory storing the target file, also stores a setting change folder with a folder name including the setting change information,
further making the computer execute:
copying the target file into the setting change folder according to a user instruction, and
wherein:
the job execution condition given to the target file is changed in the changing step, according to the setting change information extracted from the folder name, if the target file copied into the setting change folder is dragged and dropped into the icon.

13. The computer readable recording medium recited in claim 12, further making the computer execute:
deleting the target file copied into the setting change folder, after a job execution instruction is outputted in the outputting step.

14. The computer readable recording medium recited in claim 10, wherein:
the job execution condition is described in a setting change file stored in the same directory as the target file; and
a job execution condition extracted from the setting change file stored in the directory detected in the directory detecting step, is given to the target file in the setting step.

15. The computer readable recording medium recited in claim 14, further making the computer execute:
copying into the directory, setting change information stored in a setting change information storage, according to a user instruction; and
changing the job execution condition given to the target file in the condition giving step, according to the setting change information extracted from the directory detected in the directory detecting step, if the target file stored in the directory having the setting change information copied therein, is detected as being dragged and dropped into the icon, and
wherein:
a job execution instruction is outputted in the outputting step, in order to execute a job under the job execution condition changed in the changing step.

16. The computer readable recording medium recited in claim 15, further making the computer execute:
deleting the setting change information copied into the directory, after a job execution instruction is outputted in the outputting step.
